(19) United States
(12) Patent Application Publication
(10) Pub. No.: US 2012/0186055 A1
(43) Pub. Date: Jul. 26, 2012

(54) WHEEL CYLINDER SPREADER

(76) Inventor: Bing-Sheng CHEN, Taichung City (TW)

(21) Appl. No.: 13/351,499

(22) Filed: Jan. 17, 2012

(30) Foreign Application Priority Data
Jan. 25, 2011 (TW) 100201600

(51) Int. Cl. B23P 19/04

(52) U.S. Cl. 29/239

(57) ABSTRACT

The present invention provides a wheel cylinder spreader including a main body, a rod, a holding portion, and a control portion. An elongated toothed element is formed on the rod, and a leaning element is disposed on the holding portion. The holding portion can drive the rod to move due to the attachment of the leaning element and the elongated toothed element. Because the contact area of the elongated toothed element and the leaning element is larger and the transmission of force is more direct, the frequency of squeezing the holding portion is decreased and the driving efficiency is promoted. Also, the slipping and the abrasion of the elongated toothed element and the leaning element are prevented. Otherwise, when the rod is not leant by the control portion, the rod tends to move toward a specific direction due to a reposition elastic element.

### BACKGROUND OF THE INVENTION

1. Field of the Invention

The present invention relates to a wheel cylinder spreader.

2. Description of the Prior Art

A conventional spreader for adjustment of wheel cylinder is disclosed in U.S. Pat. No. 7,155,792 or U.S. Pat. No. 3,705,581. One can press the elongated toothed element by swing the handgrip to drive the rod to move toward a specific direction. However, when the rod is to be drived back to the original position, one should rotate the rod to separate the elongated toothed element and the handgrip apart. During operation, the rod is to be rotate to enable the elongated toothed element and the handgrip to contact to each other, and the handgrip can press the elongated toothed element to drive the rod to move then. Therefore, during operation of the spreader, the rod has to be rotated repeatedly and to be drawn back manually. The operation is time-consuming, laborious, and inefficient.

To improve the problem of moving speed of the rod, a wheel cylinder spreader is disclosed in TW M407133. The main idea is that the pushing element pushes the rod to move toward a specific direction via swinging the handgrip. Also, due to the cramp to the rod by the slip-preventing element, the rod can only move toward a specific direction. When a user changes the incline angle with the button, the rod moves back to the original position automatically due to the elastic element. However, this kind of design brings about many problems:

1. The slip-preventing element inclines to clamp the rod, so the surface of the rod is abraded after using for long time. Thus, the effect of limitation to the rod by the slip-preventing element is reduced.

2. The pressing effect to the rod by the elastic pusher is limited by the elastic force of the elastic pusher, so the elastic pusher has enough friction force to drive the rod to move only in a specific range of swing angle. In the other words, the moving distance of the rod drived by every swing of the handgrip is limited. Thereby, the handgrip should be squeezed many times to push the rod a predeterminate distance, so the rod moves slowly.

Thus, the conventional spreader is not durable enough and has low efficiency. How to improve the problems mentioned above is the goal of the present invention.

### SUMMARY OF THE INVENTION

The main object of the present invention is to provide a wheel cylinder spreader which is more durable and is more efficient.

To achieve the above and other objects, a wheel cylinder spreader of the present invention includes a main body, a rod, a holding portion, and a control portion.

The main body has a channel and a blocker, wherein the blocker is on an end of the channel. The rod is disposed slidably on the main body and is able to move between a first position and a second position. The rod has a reposition elastic element, and the rod tends to move toward the first position due to the reposition elastic element. The rod has an elongated toothed element and a pressing element, wherein the pressing element is located on the end near the blocker of the rod. The holding portion is disposed pivotably on the main body. A leaning element and a leaning elastic element are disposed slidably on the holding portion. The holding portion leans against the elongated toothed element via the leaning element. The holding portion swings to press against the elongated toothed element to drive the rod to move toward the second position. The control portion is disposed on the main body and includes a switch, a positioning element, and a positioning elastic element. The positioning element tends to lean against the elongated toothed element due to the positioning elastic element. The switch can drive the positioning element to move away from the elongated toothed element. The rod is able to move toward the first position only when the positioning element is away from the elongated toothed element.

Thereby, the operation of the elongated toothed element prevents the slipping and abrasion on the surface of each element, so the wheel cylinder spreader of the present invention is more durable. Besides, without the angle limitation of friction, the effect that the holding portion drives the rod move is promoted. The frequency of the squeezing holding portion is decreased, and the efficiency is promoted.

The present invention will become more obvious from the following description when taken in connection with the accompanying drawings, which show, for purpose of illustrations only, the preferred embodiment(s) in accordance with the present invention.

### BRIEF DESCRIPTION OF THE DRAWINGS

FIG. 1 is an illustration showing a wheel cylinder spreader of the present invention;

FIG. 2 and FIG. 3 are stereograms showing a wheel cylinder spreader of the present invention;

FIG. 4 is a breakdown view showing a wheel cylinder spreader of the present invention;

FIG. 5 is partial cross-section view showing a wheel cylinder spreader of the present invention;

FIG. 6 to FIG. 9 are action illustrations showing a wheel cylinder spreader of the present invention.

### DETAILED DESCRIPTION OF THE PREFERRED EMBODIMENTS

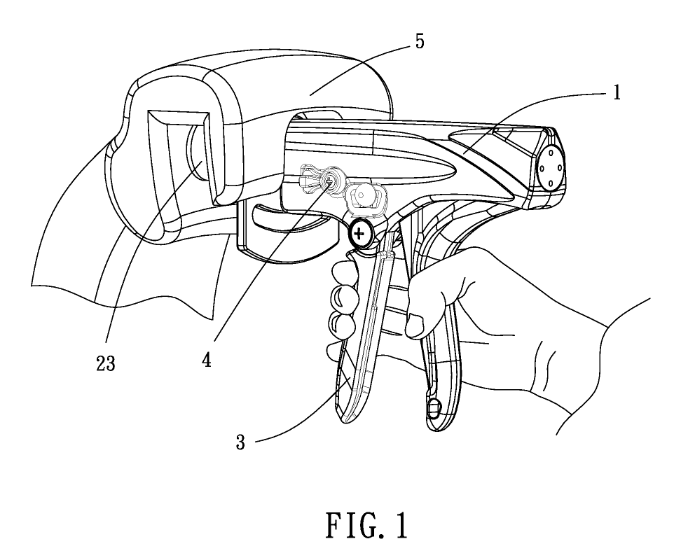

Please refer to FIG. 1 to FIG. 5, the wheel cylinder spreader of the present invention includes a main body 1, a rod 2, a holding portion 3, and a control portion 4.

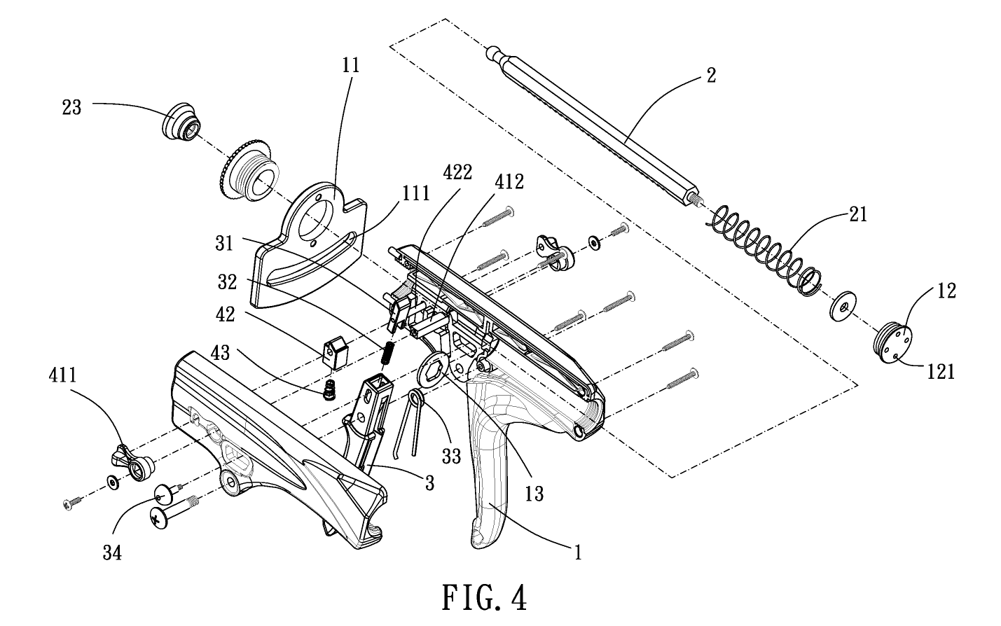

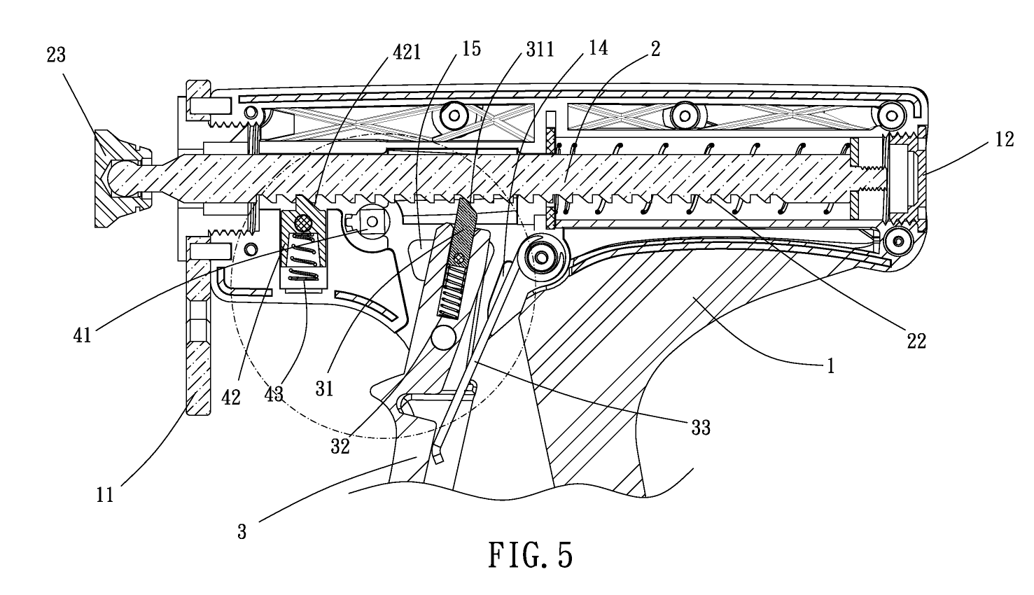

Referring to FIG. 4 and FIG. 5, the main body 1 has a channel, a blocker 11, and a limitation element 13. The blocker 11 is located on an end of the channel and forms an arc-shaped elongated hole 111. The limitation element 13 is in the channel and forms a polygonal aperture.

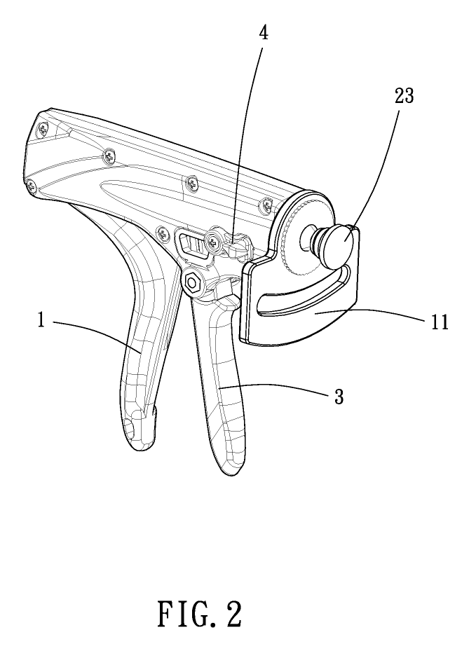

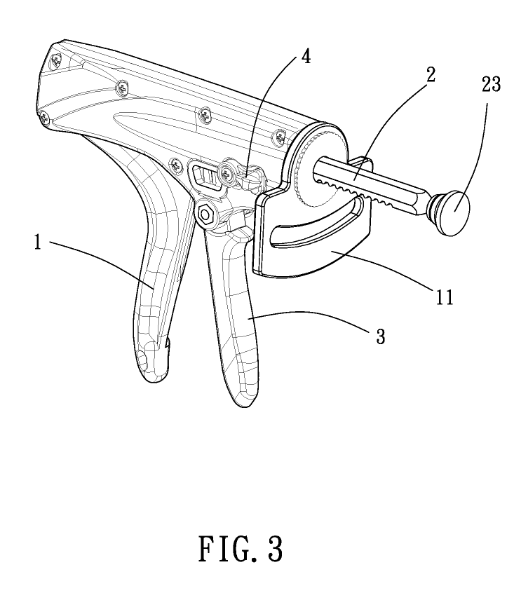

The rod 2 is disposed slidably on the main body 1 and is able to move between a first position and a second position. The rod 2 inserts into the aperture of the limitation element 13, and the shape of the aperture corresponds to the shape of the rod 2 to unenable the rod 2 to rotate relatively to the main body 1. The rod 2 has a reposition elastic element 21 which leans against the main body 1 and the rod 2. The rod 2 tends to move toward the first position due to the reposition elastic element 21. The rod 2 has an elongated toothed element 22 and a pressing element 23, wherein the pressing element 23 is located on an end near the blocker 11 of the rod 2. When the rod 2 moves between the first and the second positions, the distance between the blocker 11 and the pressing element 23 changes, as shown in FIG. 2 and FIG. 3. The main body 1 also has a base 12, as shown in FIG. 4, the base 12 is located on an end away from the blocker 11 of the channel. A plurality of pores 121 are formed on the base 12 and communicate with the channel to release pressure in the channel and to prevent the moving of the rod 2 from hindrance.

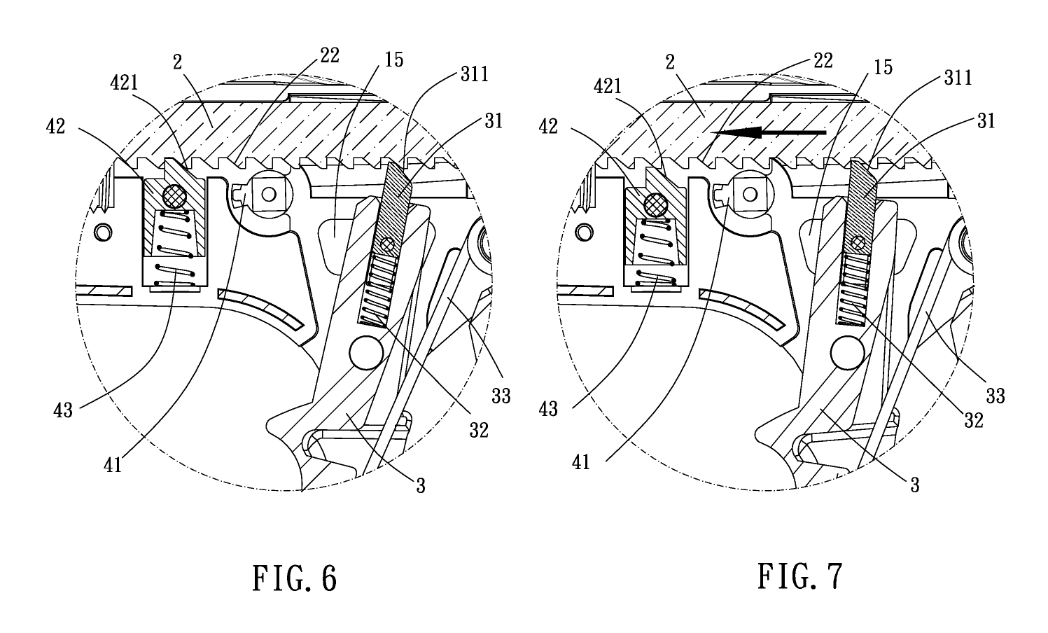

The holding portion 3 is disposed pivotably on the main body 1. The range of swing of the holding portion 3 is restricted by a limitation portion 14. A leaning element 31 and a leaning elastic element 32 are disposed slidably on the holding portion 3, wherein the leaning elastic element 32 leans against the holding portion 3 and the leaning element 31. Due to the elastic force of the leaning elastic element 32, the leaning element 31 tends to move toward the elongated toothed element 22, as shown in FIG. 6. In the major embodiment of the present invention, the holding portion 3 has a bolt 34, and the main body 1 has a limitation hole 15. The cross-section shape of the limitation hole 15 is a quadrangle. The bolt 34 inserts into the limitation hole 15 and the leaning element 31, and the bolt 34 and the leaning element 31 move simultaneously. The holding portion 3 leans against the elongated toothed element 22 via the leaning element 31. The holding portion 3 drives the rod 2 to move toward the second position by swing to push the elongated toothed element 22, wherein the elongated toothed element 22 is located on the bottom of the rod 2, and the holding portion 3 is located under the elongated toothed element 22. Without change of angle, the holding portion 3 can drive the rod 2 more directly, and the speed of rod 2 is promoted. Besides, an incline face 311 is formed on the leaning element 31. When the holding portion 3 swings toward the first position, the incline face 311 contacts to the elongated toothed element 22, and the leaning element 31 moves back due to the leaning elastic element 32. The holding portion 3 has a compress elastic element 33. The compress elastic element 33 leans against the holding portion 3 and the main body 1, and the holding portion 3 tends to swing toward a specific direction due to the compress elastic element 33, as shown in FIG. 9. When the holding portion 3 is located on the original position which the holding portion 3 is not squeezed, as shown in FIG. 9, the leaning element 31 does not lean against the elongated toothed element 22, and the rod 2 is able to move back to the first position.

Please refer to FIG. 4 and FIG. 5, the control portion 4 is disposed on the main body 1 and includes a switch 41, a positioning element 42, and a positioning elastic element 43, wherein the positioning elastic element 43 leans against the main body 1 and the positioning element 42. The positioning element 42 tends to lean against the elongated toothed element 22 and to block the rod 2. An incline face 421 is formed on the positioning element 42. When the rod 2 moves toward the second position, the elongated toothed element 22 leans against the incline face 421 of the positioning element 42. The switch 41 is located between the pressing element 23 and the holding portion 3 and is able to drive the positioning element 42 to depart from the elongated toothed element 22. Thus, a user can handle the switch 41 on the front end of the holding portion 3 with one hand and is not obstructed by squeezing the holding portion 3. The switch 41 also includes two swing elements 411 and a linking rod 412. The linking rod 412 has a quadrangle cross-section. The linking rod 412 passes through the main body 1 and is able to rotate relatively to the main body 1. The swing elements 411 are disposed on two opposite ends of the linking rod 412 respectively. In the other words, the swing elements 411 are located on the right side and the left side of the main body 1 respectively. Besides, a cross rod 422 inserts into the positioning element 42, and two opposite ends of the cross rod 422 connect to the two swing elements 411 respectively. During swinging, the swing element 411 drives the positioning element 42 to move away from the rod 2 and cancels the restriction to the rod 2 by the positioning element 42. Thus, the rod 2 is able to move toward the first position when the positioning element 42 is away from the elongated toothed element 22. In the major embodiment of the present invention, the elastic elements are metal springs.

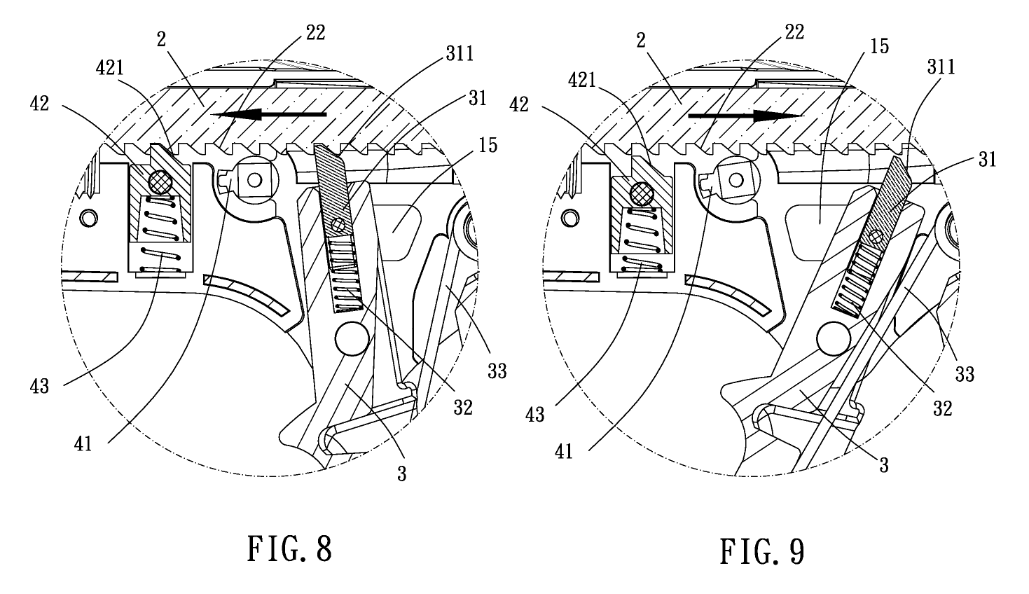

When the rod 2 is to be moved, a user can squeeze the holding portion 3 to swing toward a specific direction. During swinging, as shown in FIG. 6, the leaning element 31 pushes the elongated toothed element 22 and drives the rod 2 to move toward the second position, as shown in FIG. 7 and FIG. 8. When the holding portion 3 swings to a maximum angle, reducing the force of squeezing the holding portion 3 causes the holding portion 3 to swing toward the opposite direction due to the compress elastic element 33. The rod 2 is unable to move toward the first position due to the hindrance by the positioning element 42. When canceling the hindrance to the rod 2 by the positioning element 42 to drive the rod 2 back to the first position, one can pivot the switch 41 to drive the positioning element 42 to move away from the elongated toothed element 22, as shown in FIG. 9. In the same time, the positioning element 42 does not lean against the rod 2, and the reposition elastic element 21 draws the rod 2 back toward the first position.

Thereby, the characteristic of the present invention is that the holding portion drives the rod to move via the contact between the leaning element and the elongated toothed element. The contact area of the elongated toothed element and the leaning element is larger, and the transmission of force is more direct. In addition to the promoted operation efficiency, slipping and abrasion of the contact surface of the elongated toothed element and the leaning element are prevented. The most important is that the swing angle is not limited because the operation is not relative to friction. When the leaning element contacts to the elongated toothed element, the rod is drived to move because of lever principle. Thus, the distance which the rod is pushed is larger when the holding portion swings. The speed of the rod is promoted, and the frequency that the holding portion is squeezed is reduced. Then, the efficiency is promoted. Besides, the size and the shape of the elongated toothed element, the leaning element, or the positioning element are adjustable. For example, the elongated toothed element with denser teeth can provide more precise adjustment. Moreover, a user can just turn the switch to draw the rod back toward the first position.

In conclusion, the wheel cylinder spreader of the present invention has a simplified structure, and the operation is not concerned with friction. The abrasion and slipping are prevented because the elongated toothed element and the leaning element are used. The most important is that the efficiency is promoted due to the larger range of swing.

What is claimed is:

1. A wheel cylinder spreader, includes:
a main body, having a channel and a blocker, the blocker being located on one end of the channel;
a rod, being disposed slidably on the main body, the rod being able to move between a first position and a second position along the channel, the rod having a reposition elastic element, the rod tending to move toward the first position due to the reposition elastic element, the rod also having an elongated toothed element and a pressing element, the pressing element being located on an end of the rod near the blocker;
a holding portion, being disposed on the main body pivotably, a leaning element and a leaning elastic element being disposed slidably on the holding portion, the leaning element tending to move toward the elongated toothed element due to the leaning elastic element, the holding portion leaning against the elongated toothed element via the leaning element, the holding portion being able to swing to lean against the elongated toothed element to drive the rod to move toward the second position;
a control portion, being disposed on the main body, the control portion including a switch, a positioning element, and a positioning elastic element, the positioning element tending to lean against the elongated toothed element due to the positioning elastic element, the switch being able to drive the positioning element to depart from the elongated toothed element;
wherein the rod is able to move toward the first position only when the positioning element is away from the elongated toothed element.

2. The wheel cylinder spreader of claim 1, wherein a base is disposed on the main body, at least one pore is formed on the base, the pore communicates with the channel.

3. The wheel cylinder spreader of claim 1, wherein a limitation element is disposed on the main body, an aperture is formed on the limitation element, the aperture has a corresponding shape to the rod to unenable the rod to rotate relatively to the main body.

4. The wheel cylinder spreader of claim 1, wherein the holding portion has a bolt, a limitation hole is formed on the main boy, the bolt inserts into the limitation hole and the leaning element, the bolt is able to move simultaneously when the leaning element moves.

5. The wheel cylinder spreader of claim 1, wherein the elongated toothed element is located on a bottom of the rod.

6. The wheel cylinder spreader of claim 5, wherein the switch includes two swing elements and a linking rod, the linking rod passes through the main body transversely and is able to rotate relatively to the main body, the swing elements are disposed on the two opposite ends respectively, the two swing elements are located on a right side and a left side respectively.

7. The wheel cylinder spreader of claim 6, wherein the switch is located between the pressing element and the holding portion.
